(19) United States
(12) Patent Application Publication
(10) Pub. No.: US 2025/0268413 A1
(43) Pub. Date: Aug. 28, 2025

(54) Rice Cooker Steaming System

(71) Applicant: James Warner Haskins, San Diego, CA (US)

(72) Inventor: James Warner Haskins, San Diego, CA (US)

(21) Appl. No.: 19/049,506

(22) Filed: Feb. 10, 2025

Related U.S. Application Data
(60) Provisional application No. 63/557,105, filed on Feb. 23, 2024.

(51) Int. Cl. A47J 27/04

(52) U.S. Cl. CPC A47J 27/04; A47J 2027/043

(57) ABSTRACT

A cooking insert is provided which is configured for operative engagement with a rice cooker to position a reservoir elevated above cooking food. Water vapor and carbohydrates from condensed steam is captured in the reservoir to reduce the starch within the cooking food.

### FIELD OF THE INVENTION

This application claims priority to U.S. Provisional Patent application Ser. No. 63/557,105 filed on Feb. 23, 2024.

The disclosed device relates to a cooker for rice and similar grain-based foods. More particularly, it relates to a cooker with a separable insert for positioning within the cooking cavity of a table top rice cooker. In a first configuration, the primary insert allows for normal cooking of rice in the rice cooker. The primary insert is engageable with a secondary insert for cooking in a second configuration which yields a meal of rice with reduced carbohydrate content.

### BACKGROUND OF THE INVENTION

Conventional rice cookers, which are functionally similar to slow cookers, have become ever more popular throughout the world. In such conventional electric cookers or rice cookers, the cooker is turned on by the user using a switching means, such as a mechanical or push button switch. Thereafter, heating elements of the cooker are activated only to cause the temperature of the cooking cavity in the cooker pot to rise to a temperature which is only sufficient for boiling the contents, such as uncooked rice.

In a boiling sequence in conventional cookers, the mixture of rice and liquid or other contents within the cooking cavity of the rice cooker rises in temperature only to a boiling point using the heat from the heating element which is activated once the user switches the cooker to an “on” position. During the boiling sequence, the temperature of the cavity causes a boiling of the water therein cooking the rice mixed with the water. In this process, water vapor from boiling constantly returns to the mixture which contains dissolved carbohydrate from the exterior surface of the rice. As the vapor cools, the water and dissolved carbohydrate are returned to the cavity and the mixture of water and rice.

Such conventional rice cookers are widely available with a cooker unit which surrounds a single cooking area housed within the sidewall of the cooker unit and underneath a removable lid. This conventional arrangement limits the amount of food which may be cooked to a single cooking area within the cooker unit. It also can tend to maintain a high carbohydrate level of the finished rice due to the constant return of water vapor and dissolved carbohydrate therein.

The forgoing examples of related rice cooker art and limitations related therewith are intended to be illustrative and not exclusive, and they do not imply any limitations on the disclosed rice cooker insert described and claimed herein. Various additional limitations of the related art will become apparent to those skilled in the art upon reading and understanding the specification below and the accompanying drawings.

In this respect, before explaining at least one embodiment of the rice cooker with a separable insert herein in detail, it is to be understood that the rice cooker invention is not limited in its application to the details of construction and to the arrangement of the components set forth in the following description or illustrated in the drawings nor the steps outlined in the specification.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes of the rice cooker with a separable insert as disclosed herein. It is important, therefore, that the claims be regarded as including such equivalent construction insofar as they do not depart from the spirit and scope of the present invention.

### OBJECTS OF THE INVENTION

An object of this invention is the provision of an insert for positioning within a conventional rice cooker and the like, which in one configuration will capture water vapor and dissolved carbohydrate in a reservoir before it is returned to the boiling mixture below.

It is another object of this invention as a complete unit which includes an insert for a rice cooker which is formed of two separable components, whereby in a first configuration carbohydrate is captured, and in a second separated configuration steam and water return to the boiling mixture in a substantially normal fashion while providing an elevated shelf for cooking of a secondary food thereon.

It is another object of this invention to provide the separable water and carbohydrate capturing component which may be employed as an addition for insertion into existing conventional rice cookers.

It is yet another object of this invention to provide a tabletop rice cooker in combination with an onboard heat source which includes an insert for cooking rice which captures carbohydrate such as starch from steam communicated from a lower rice cooking insert.

These, together with other objects and advantages of the disclosed rice cooker separable insert herein, which will become subsequently apparent to those skilled in the art, reside in the details of the construction and method herein as more fully hereinafter described and claimed, reference being had to the accompanying drawings forming a part thereof, wherein like numerals refer to like parts throughout.

### SUMMARY OF THE INVENTION

The insert device for a conventional rice cooker herein described and disclosed, in all preferred modes, includes an insert device which is preferably formed of two separable components. It is this separable configuration of the insert that provides the most utility and function to the user for cooking.

The insert device is configured to be used in combination with a conventional rice cooker or table top cooker. Such cookers allow the user to position rice and water in a mixture within a cooking cavity of the rice cooker. Such conventional cookers include a lid that provides a removable seal when positioned upon the top of the sidewall of the cooker, thereby holding moisture from boiling water and cooking within the cooker.

The insert device has an exterior circumference configured for positioning within the inside surface of the sidewall of the cooking cavity of the rice cooker. Preferably, the exterior circumference of the insert device such as that of a sidewall, at least in an assembled configuration, may be located in contact with or adjacent the interior circumference of the cooking cavity of the rice cooker. Such allows for at least a partial seal between the exterior circumference of the insert and the interior wall of the rice cooker.

Thus, in some modes of the insert device it can be manufactured with the exterior circumference thereof to substantially match the interior circumference of the cooking cavity of the rice cooker into which it engages. However, the insert device may also be provided with one or more engageable polymeric seals thereby allowing a distal edge of the sidewall of one insert to engage with a number of differently sized rice cookers.

As noted, it is preferred that the insert device is formed as a first insert component with a second insert component or engageable atop a second insert component of a rice cooker. This allows the user to configure the insert for a first configuration of operation wherein water vapor is captured and a second configuration of operation wherein substantially all the water vapor and carbohydrate return to the boiling mixture. Additionally, where provided as a full rice cooking unit, a cooking shelf may be provided for positioning of a second foodstuff thereon for concurrent cooking with the rice. The user, thus, can configure the device for operation in the desired configuration for each instance of cooking rice within a rice cooker hosting the insert device herein.

In the first configuration of operation including the employment of the insert device, the user can engage the first insert component to a removable attachment with an underlying second insert component. The first insert component has a central receiving conduit, which is configured to engage over a central conduit extending from a central area of the second insert component which is held elevated within the rice cooking cavity of the cooker. Once so engaged, a passageway for vapor emanating from cooking rice and water is formed. The passageway allows rising water vapor and dissolved carbohydrate to pass therethrough in a direction toward a lid sealing the top opening of the rice cooker.

As the vapor rises and cools, it condenses to a liquid. The liquid along with any starch therein is collected within a reservoir formed in the first insert component. The reservoir surrounds the central receiving conduit and is surrounded by a sidewall of the first insert component. A solid bottom wall of the first insert component, which is held elevated above the cooking rice or food within the cooking cavity, insures that the water vapor, so captured, condenses and stays within the reservoir of the first insert component.

This capturing of water vapor and dissolved carbohydrate before such would normally return to the boiling mixture of water and rice within the cooking cavity of the rice cooker significantly lowers the overall carbohydrate content of the cooked rice.

Where the user wishes to allow cooking within a rice cooker in a substantially normal fashion, the first insert component may be separated from the second insert component. Thereafter, solely, the second insert component may be inserted into the rice cooker. This second insert component has a bottom wall which is held elevated with the second insert component positioned within the rice cooker which has passages communicating therethrough. The passages allow condensing water vapor and dissolved solids to return to the boiling mixture of rice and water during cooking.

This second insert component may be configured with the bottom wall wherein it will be engaged within the cooking cavity of the rice cooker elevated above the underlying cooking mixture of water and rice within the rice cooker. It, thus, provides an elevated shelf for positioning of one or more foods thereon to be cooked concurrently with the rice by the heat and heated vapor rising from the boiling mixture of water and rice.

This separable configuration of the first and second insert components provides the user with the ability to choose to cook in a low carbohydrate mode or in a conventional mode. It also provides the user an elevated cooking shelf, when cooking in the conventional mode, thereby allowing concurrent cooking of multiple foods at the same time while saving energy.

With respect to the above description then, it is to be realized that the dimensional relationships for the components of the rice cooker insert invention may also include variations in size, materials, shape, form, function and manner of operation, manner of formation, assembly and use, which are deemed readily apparent and obvious to one skilled in the art subsequent to their review of this specification. Therefore, the foregoing summary and following description are considered as illustrative only of the principles of the invention to provide a separable insert for a rice cooker or similar counter top cooker, which allows the user to employ it for both low carbohydrate cooking and normal cooking of rice and similar grains.

Additionally, since numerous modifications and changes will readily occur to those skilled in the art subsequent to their review of this disclosure, it is not desired to limit the invention to the exact construction and operation and steps of formation and employment shown and described, and accordingly, all suitable modifications and equivalents which may be resorted to, are considered to fall within the scope of the invention.

### BRIEF DESCRIPTION OF THE DRAWINGS

The accompanying drawings, which are incorporated herein and form a part of the specification, illustrate some but not the only or exclusive examples of embodiments of the rice cooker separable insert device herein. It is intended that the embodiments and figures disclosed herein are to be considered illustrative of preferred modes of the device and the system rather than limiting.

FIG. 1 depicts the insert in an assembled configuration of the first insert component and the second insert component which may be inserted into a conventional rice cooker to a mounted position, as shown in FIG. 2.

FIG. 2 depicts the assembled insert device, removably engaged in a first configuration with a rice cooker or the like, and shows the reservoir for capturing condensed water vapor and carbohydrate surrounding a central pathway which communicates with the area above the cooking area of the cooker.

FIG. 3 is a sectional view through FIG. 2 showing the communication of water vapor and dissolved solids such as starch therein, through a formed central passageway wherein it condenses below the sealing lid of the cooker and falls into and is held in the reservoir formed by an interior cavity of the engaged first insert component.

FIG. 4 shows the body forming first insert component removed from engagement with the second insert component wherein the user may position the second insert component within a rice cooker or the like in a conventional fashion, as in FIG. 5.

FIG. 5 shows the second configuration of the insert device herein using solely the second insert component which forms a shelf for secondary food cooking of food thereon where the shelf has a plurality of openings formed therein for the passage of heat and vapor.

### DETAILED DESCRIPTION OF THE INVENTION

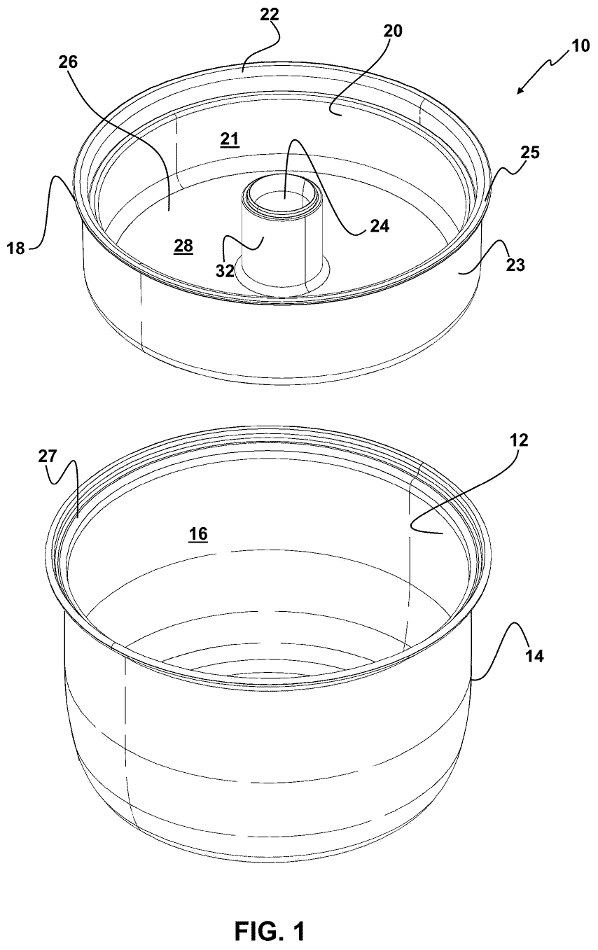

Referring now to the drawings in FIGS. 1-5, wherein similar parts of the rice cooker separable insert invention are identified by like reference numerals:

There is seen in FIG. 1, the assembled insert device 10 positioned for operable insertion into the internal cavity 12 or cooking area of a table top rice cooker 14 or similar table top cooking device, such as a crock pot. Preferably, the exterior circumference of the second sidewall 23 of the second insert 22 of the device 10, is sized for positioning close to the interior surface 16 of the cooking cavity of the rice cooker 14. As noted below, a lip 25 extending from the distal end of the second sidewall 23 is sized for positioning atop the ledge 27 of the rice cooker which is normally used to hold the lid 38 thereon.

Alternatively, one or a plurality of polymeric seals (not shown but well known) may be provided for engagement upon the lip 25 to form such a seal and allow differently sized seals to engage with differently sized interior cavities 12. This would allow a wider use of the insert device 10 as a stand-alone device employable with the rice cookers 14 of different manufacturers by placing the appropriately sized seal upon the upper edge 18 of the second sidewall 23 of the assembled insert device 10.

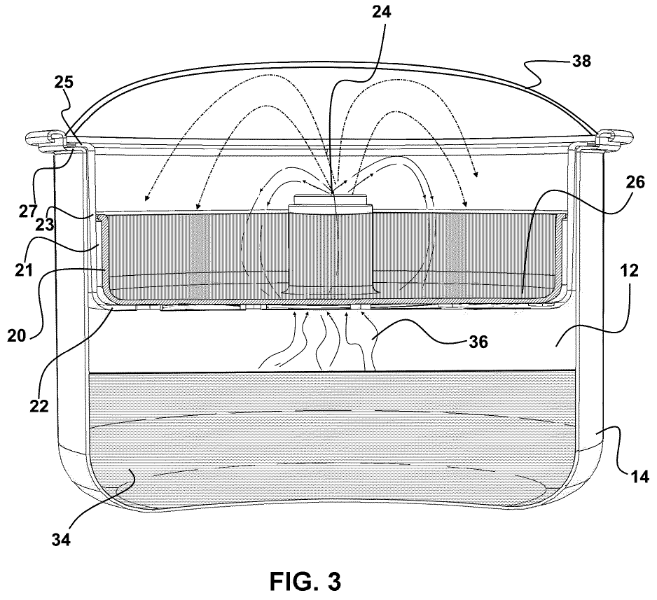

The lip 25 extends away from the distal end of the second sidewall 23 of the second insert 22. This lip 25 is sized for positioning upon a ledge 27 surrounding the opening to the interior cavity 12 of the rice cooker. The lip 25 is positionable to a circular engagement upon the ledge 27 to hold the second insert component 22 elevated within the internal cavity 12 of a rice cooker. So positioned the lid 38 is positionable atop the lip 25 to seal the cavity 12 such as in FIG. 3. Projections from the distal end of the second sidewall 23 might also be employed but a continuous lip 25 is preferred to maintain the seal when the lid 38 is placed atop to lip 25.

In the assembled mode such as in FIGS. 1 and 3 of the insert device 10 herein, the underlying second insert component 22 which is held elevated within the interior cavity 12 of the rice cooker by the lip 25, operatively engages with a the first insert component 20. While so engaged, a passageway 24 is formed to allow communication of water vapor and dissolved solids therethrough during the cooking process. This vapor and dissolved solids will be collected within the formed reservoir 26 of the first insert component 20 which is mounted within and held elevated above the second insert component 22.

It should be noted that the insert device 10 herein can be provided as first insert component 20 to be mounted and used in combination with a rice cooker 14 or the like which is configured with an underlying second insert component 22. Further, the insert device 10 may also be provided separately and later operatively positioned for use in any existing rice cooker 14 or similar table top cooker which will hold the insert device 10 within the cooking cavity or interior cavity 12 in an operable engagement with the second insert component 22 held engaged to the first insert component 20 and held elevated above the bottom of the interior cavity 12 which is for holding rice.

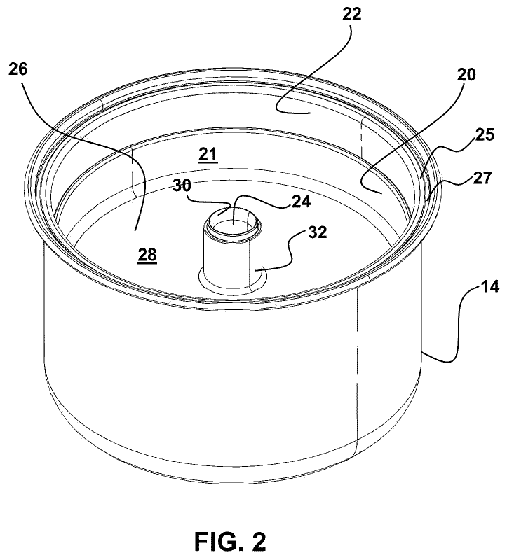

Shown in FIG. 2 is the result of the insertion of the insert device 10, shown in FIG. 1, into an operative engagement with the interior cavity 12 of a conventional rice cooker 14 or the like. By operative engagement herein is meant, that a mount on the second insert component 22 such as a lip 25 or mating connector connects to the rice cooker in a manner to hold the second insert component 22 elevated within the internal cavity 12 such as on a ledge 27. As shown, the reservoir 26 of the first insert component is defined atop the surrounding surface 28 and within the first sidewall 21 which surrounds a projecting receiving conduit 32 of the first insert component 20. A first passage 31 communicates through the receiving conduit 32 and has openings on both ends thereof.

Currently, one preferred mode of separable engagement of the first insert component 20 with the second insert component 22 is a coaxial engagement of the central conduit 30 extending from the second insert component 22 with the central receiving conduit 32. When in this engaged position a passageway 24 is formed that communicates air and steam from below the cooking shelf 45 for the second insert component 22 through a formed passageway 24 where it condenses and settles within the reservoir.

This coaxial engagement may be a simple frictional fit of the interior of the receiving conduit 32 over the exterior surface of the central conduit 30. However, a threaded engagement noted below has shown in experimentation to provide for an easier connection and separation of the two components since they automatically separate when rotated.

Shown in FIG. 3 is a depiction of a sectional view through the center of the assembled components of the device 10 as in FIG. 2. As shown, a boiling water and food mixture 34 is cooked within a lower end of the interior cavity 12 of a conventional rice cooker 14 or similar table top cooker and below the elevated cooking shelf 45. Water vapor and dissolved solids 36, such as starch or carbohydrate from the rice or food in a mixture of boiling water and food 34 rises through the formed passageway 24 and is held within the cooker 14 by the lid 38. The device 10 is held elevated by the lip 25 positioned on the ledge 27 whereby the lid 38 can sit atop and form a seal. Other means to operatively hold the device 10 elevated within a rice cooker may be used, such as, for example, a frictional fit.

Upon cooling, the water vapor 36 and dissolved solids settle into the reservoir 26 rather than being returned to the boiling water and food 34 being cooked. This settling and separation significantly reduces the amount of carbohydrate such as starch within in the cooked rice, once finished cooking. The user can, as such, use the insert device 10 in the assembled mode to reduce the carbohydrate of their cooked food.

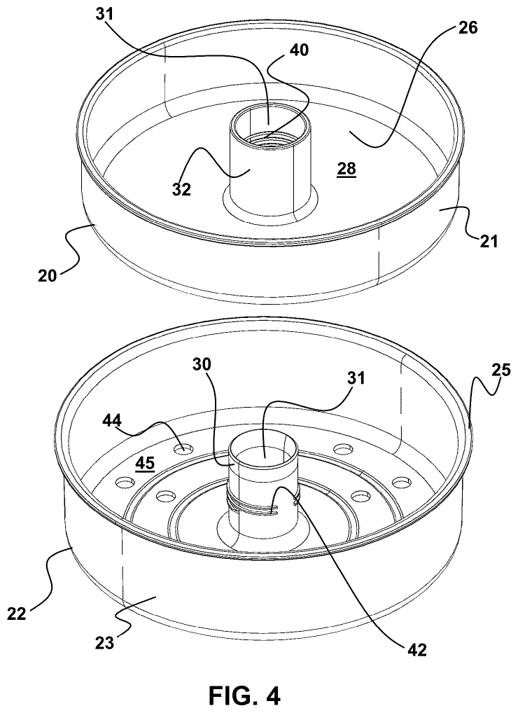

In FIG. 4 is shown the insert device 10 herein having the first insert component 20 removed from engagement with the second insert component 22. As noted, this engagement may be frictional or may be accomplished by a first threaded area 40 within the central receiving conduit 32 which will engage with secondary threaded area 42 on the exterior of the central conduit 30. This allows for a simple rotation of the two components in opposite directions to engage and separate them.

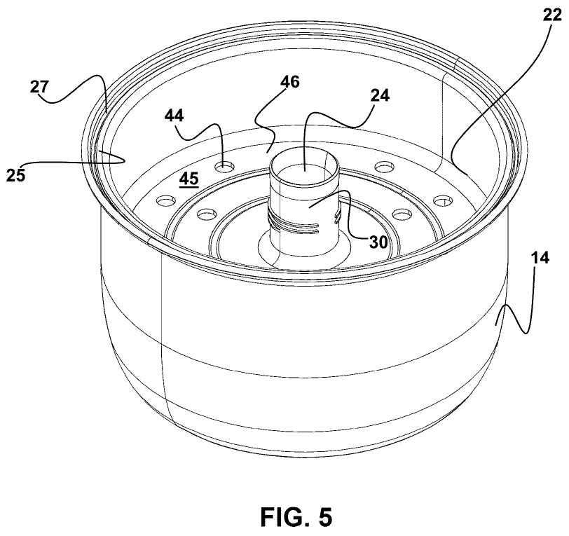

In this separated configuration, which may also be the configuration of a conventional rice cooker not including the device 10 herein, the user may position the second insert component 22 within the interior cavity 12 of a rice cooker or the like, as in FIG. 5 with the lip 25 positioned on the ledge 27 to hold it elevated. This user-chosen configuration allows for cooking by boiling water and rice in a mixture 34 in the same manner as shown in FIG. 3. However, openings 44 in the lower surface 46 of the second insert component 22 allow the return of vapor and dissolved solids communicated from the passageway 24 to return to the cooking mixture 34 in the conventional fashion should the user wish to cook in that manner.

Additionally, the lower surface 46 of the second insert component 22 provides a cooking shelf 45 which is elevated above the cooking mixture 34. This allows the user to place additional foodstuffs such as vegetables or meat or other solid foods (not shown but well known) to be cooked upon the formed shelf 45 and use the heated vapor and rising heat from the cooker 14 to concurrently cook additional foodstuffs, saving energy and time.

As noted above, while the present cooker insert invention has been described herein with reference to particular embodiments thereof and steps in the method of employment of the modes thereof, a latitude of modifications, various changes and substitutions are intended in the foregoing disclosures, it will be appreciated that in some instance some features or steps in configuration and employment of the rice cooker separable insert invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. An insert for engagement within a cooking cavity of a rice cooker, comprising:
a first insert body having a receiving conduit extending from a surrounding surface;
a first sidewall extending a perimeter area of said surrounding surface;
a reservoir defined by an area above said surrounding surface and within said first sidewall; and
said first insert body configured for positioning within a cooking cavity of a rice cooker to an engaged position having said surrounding surface suspended above a cooking area of said cooking cavity, whereby steam rising from said cooking cavity is communicated through said receiving conduit whereby said steam is condensed to water and starch contained therein is captured in said reservoir.

2. The insert for engagement within a cooking cavity of a rice cooker of claim 1 additionally comprising:
a second insert body, said second insert body having a central conduit extending from a shelf, said shelf having a second sidewall extending above a perimeter area thereof;
said receiving conduit of said first insert body coaxially positionable to a connection with said central conduit;
a lip extending from a distal end of said second sidewall;
said lip positionable upon a ledge encircling an opening communicating with said cooking cavity of said rice cooker; and
whereby said first insert body held to said engaged position by said connection of said receiving conduit with said central conduit with said lip concurrently posited upon said ledge.

3. The insert for engagement within a cooking cavity of a rice cooker of claim 2 wherein said receiving conduit of said first insert body is coaxially positionable to a connection with said central conduit in an engagement of a first threaded area within said receiving conduit with a second threaded area on said central conduit.

4. The insert for engagement within a cooking cavity of a rice cooker of claim 1 additionally comprising:
openings communicating through said shelf; and
said openings forming a path for steam therethrough whereby food positioned upon said shelf can be heated.

5. The insert for engagement within a cooking cavity of a rice cooker of claim 2 additionally comprising:
openings communicating through said shelf; and
said openings forming a path for steam therethrough whereby food positioned upon said shelf can be heated.

6. The insert for engagement within a cooking cavity of a rice cooker of claim 3 additionally comprising:
openings communicating through said shelf; and
said openings forming a path for steam therethrough whereby food positioned upon said shelf can be heated.
